(19) United States
(12) Patent Application Publication
(10) Pub. No.: US 2014/0063469 A1
(43) Pub. Date: Mar. 6, 2014

(54) PROJECTOR DRIVEN TELEPROMPTER

(71) Applicant: BDL AUTOSCRIPT INC., Shelton, CT (US)

(72) Inventors: Michael A. Folcik, Milford, CT (US); William E. Flynn, JR., Naugatuck, CT (US)

(73) Assignee: BDL AUTOSCRIPT INC., Shelton, CT (US)

(21) Appl. No.: 14/017,091

(22) Filed: Sep. 3, 2013

Related U.S. Application Data
(60) Provisional application No. 61/695,895, filed on Aug. 31, 2012.

(51) Int. Cl. G03B 21/28; G03B 21/10

(52) U.S. Cl. CPC G03B 21/28; G03B 21/10
USPC 353/79; 353/98; 353/94

(57) ABSTRACT

A teleprompter suited for use with a camera having a lens with a field of view defined by an axis in a forward direction. The teleprompter includes, generally, a reflector supported proximate the lens; a projection screen supported forward of the reflector; a projector supported forward of the reflector for projecting an image on the projection screen so that the image is capable of reflection by the reflector along the axis. The projection screen being preferably concave and oriented such that the projected image projected by the projector onto the projector screen is reflected by the reflector along the axis of the lens in a forward direction.

### CROSS REFERENCE TO RELATED APPLICATION

This application claims the benefit of U.S. Provisional Application No. 61/695,895 filed Aug. 31, 2012, herein incorporated by reference in its entirety for all purposes.

### FIELD OF THE INVENTION

The present invention relates to a system and method for displaying information to a subject in front of a camera. More particularly, but not by way of limitation, the present invention relates to a lightweight teleprompter which employs a projector to provide a display on-axis with a camera lens.

### BACKGROUND OF THE INVENTION

Teleprompters (or “prompters”) are well known in the art. Generally speaking, a teleprompter attaches to a camera and provides a display on-axis with the camera lens. Such devices are used to provide on-air talent with scrolling text, or a script, so that the talent can read the text while looking into the camera lens. In a typical studio environment a camera is likely mounted to a pedestal-style camera support with a robotic pan/tilt head. The prompter is typically mounted so that the prompter moves with the camera to remain in front of the camera lens. Optionally, an on-air or talent monitor may be mounted below the teleprompter so that the talent can see how he or she appears or see the programming being telecast.

Present day teleprompters use an LCD monitor directed towards a reflective surface placed in front of the lens. The image from the LCD monitor is then reflected along the axis of the lens, toward the subject. Ideally all of the light from the monitor either passes through the reflective surface, perpendicular to the axis of the lens, or is reflected away from the camera, towards the subject, with none of the image finding its way into the camera. Even if some of the image was visible to the camera, it would normally be very poorly focused since the camera is focused on the talent.

For a variety of reasons, there is constant pressure in the industry to reduce the weight of teleprompters. One reason lighter weight prompters are desirable is that the weight of the prompter affects the size of support needed. In studio applications, for example, a robotic pedestal and robotic pan/tilt assembly must be sized to carry not only the weight of camera and its associated cabling, but also the prompter and the cables required by the prompter. The cost of such systems is directly affected by the weight of the equipment supported.

Of particular concern for television news crews, in remote applications, is that the size of a tripod must also take into consideration the weight of the prompter. Thus, if a reporter uses a prompter, the crew not only has to deal with the prompter, but the support for the camera will be bulkier and heavier than would be required without a prompter.

The LCD monitor used in modern-day teleprompters provides a significant percentage of the weight of the entire system. Further, since the monitor is typically cantilevered in front of the camera, the weight of the hardware necessary to support the monitor is directly proportional to the weight of the monitor. Thus any reduction in the weight of the monitor results in a further weight savings in the form of smaller brackets to hang the monitor. These savings, in turn, reduce the size, weight, and cost of the attendant camera support. It should also be noted that typically the entire weight of the prompter is outboard of the lens, thus increasing the tendency of the camera to pitch downward. Weight, therefore, is a key consideration for purchasers of teleprompters.

It is thus an object of the present invention to provide a prompter system that is lighter weight than prior art prompter systems.

It is a further object of the present invention to provide a prompter system which is more compact than prior art systems without sacrificing viewing area of either the prompter or the on-air monitor.

It is yet a further object of the present invention to provide a talent monitor used in conjunction with a teleprompter which is likewise more compact and lighter weight.

### SUMMARY OF THE INVENTION

The present invention provides a highly portable, lightweight prompter system with reductions in weight and size as compared to prior art systems. In a preferred embodiment the inventive teleprompter includes: a housing; a reflective surface mountable in front (forward) of a camera lens such that the lens views an image beyond the reflective surface along an axis; a projector attached to the housing (forward of the reflector) and directed toward a screen on which a projected image from the projector is shown, the projection screen being oriented with the reflective surface reflectors such that the projected image is reflected from the reflective surface/reflector along the axis of the lens toward the subject of the camera.

In one preferred embodiment, the projector is a pico projector which is a very small, compact, lightweight video projector. Since the projector is significantly smaller and lighter than the monitor used in prior art prompter systems, the bracketry, and related hardware, can also be smaller and lighter. In addition, the image size of the projector can be adjusted so that the same projector and same software can be used on many different sized prompters, thus reducing inventory requirements for the manufacturer.

In another preferred embodiment a second projector is mounted below the prompter and directed towards a rear projection screen, likewise mounted below the prompter, proximate the front of the prompter to provide a talent monitor.

### BRIEF DESCRIPTION OF THE DRAWINGS

FIG. 1 shows the inventive highly portable, lightweight prompter system in its general environment.

FIG. 2 provides an isometric view of the inventive prompter from the right side, in front of the prompter.

FIG. 3 provides an isometric view from the back and left side of the inventive prompter.

FIG. 4 depicts a pico projector suitable for use with the teleprompter of the present disclosure.

FIG. 5 shows a preferred embodiment to the inventive prompter which includes a talent monitor.

### DETAILED DESCRIPTION OF THE PREFERRED EMBODIMENTS

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

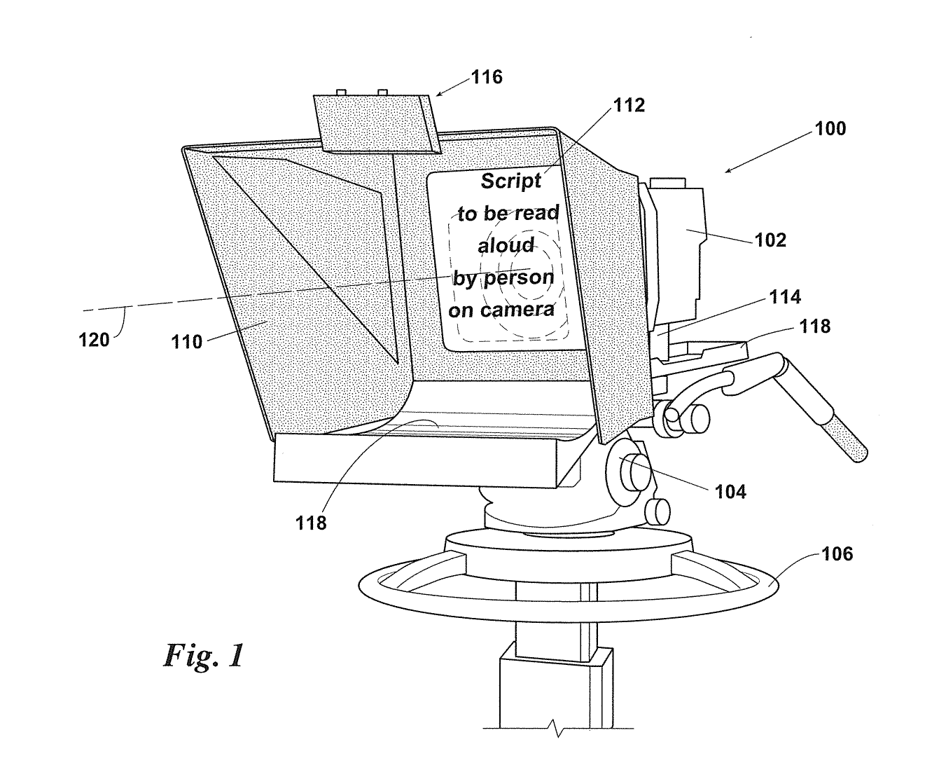

Referring now to the drawings, wherein like reference numerals indicate the same parts throughout the several views, the inventive teleprompter system 100 is shown in its general environment in FIG. 1. In a typical installation, prompter 100 is mounted to, or proximate to, a camera 102, which is in turn mounted to a pan/tilt head 104, which is in turn mounted to a support 106, in this case a pedestal-style support. In ever-increasing numbers, pan/tilt units and pedestals are robotic in nature, reducing the need for cameramen. However, where such units are manual, or even just capable of manual operation, camera 102 is typically equipped with a viewfinder or monitor (not shown).

Preferably the inventive prompter 100 comprises: a housing 114 including sides 110; a reflective surface, or reflector, 112 housed in housing 114; and a projector 116 mounted to housing 114 and directed toward a projection screen 118, such that images projected from projector 116 onto projection screen 118 are reflected by surface 112 and visible in front of the lens of camera 102. Thus, a subject in front of the camera can see the information projected from projector 116 (as reflected by reflector 112), preferably text, while looking directly into the camera 102. Mounting hardware 118 attaches prompter 100 to camera 102 and or pan/tilt assembly 104.

In a multi-camera environment, prompter 100 may further include a numeric display (not shown), which shows a camera number to aid the subject or production staff. In addition, the numeric display may be capable of selectively changing color, or selective illumination, so that the active camera can be clearly indicated to the talent and production staff. Typically, the numeric display would be mounted on top of, or proximate to, projector 116. Further, a digital clock (not shown) may be mounted under the prompter so that the talent can see the current time without looking away from the camera. Target times may be embedded in the script presented on the teleprompter so that the talent can adjust her or his cadence to stay on schedule, particularly in live broadcasts.

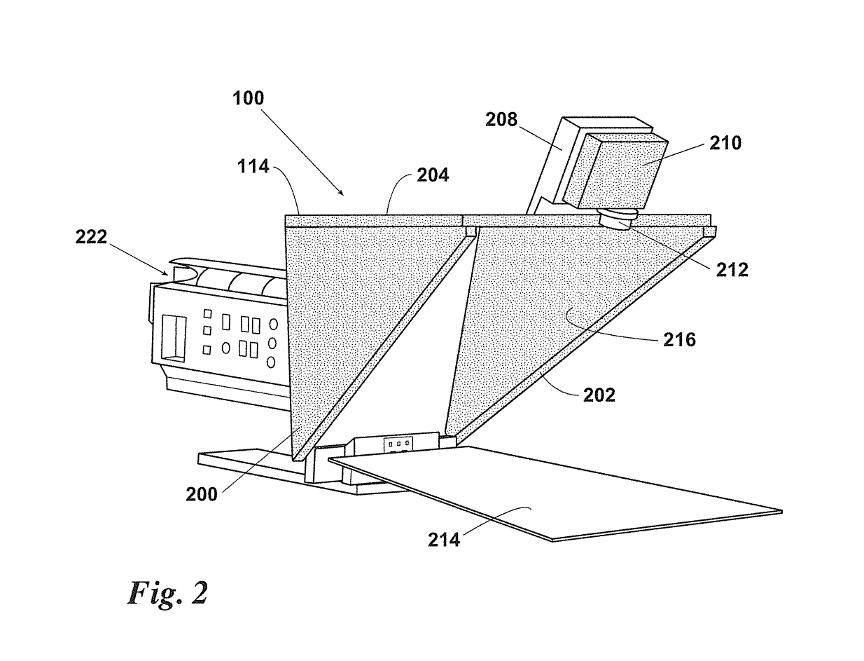

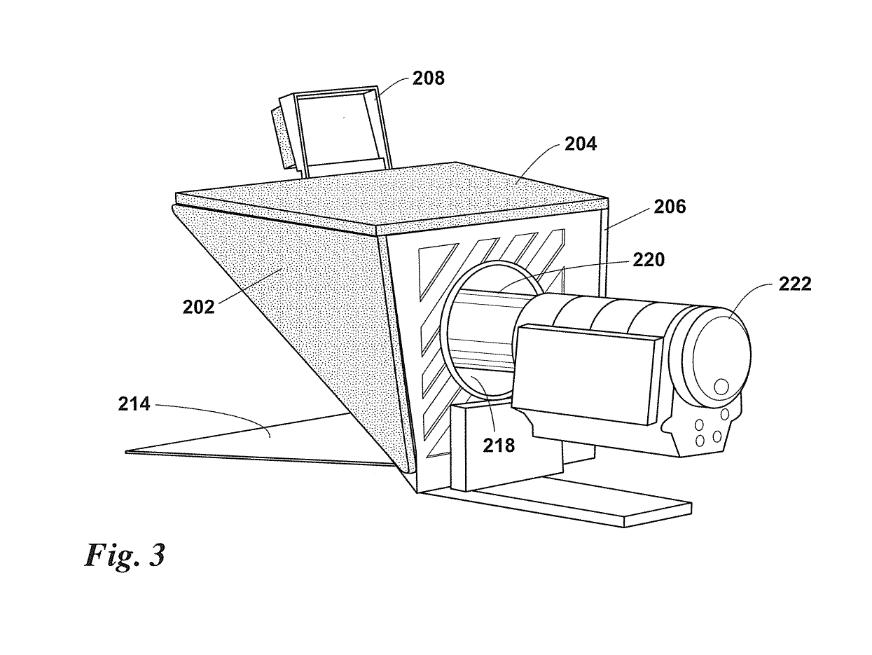

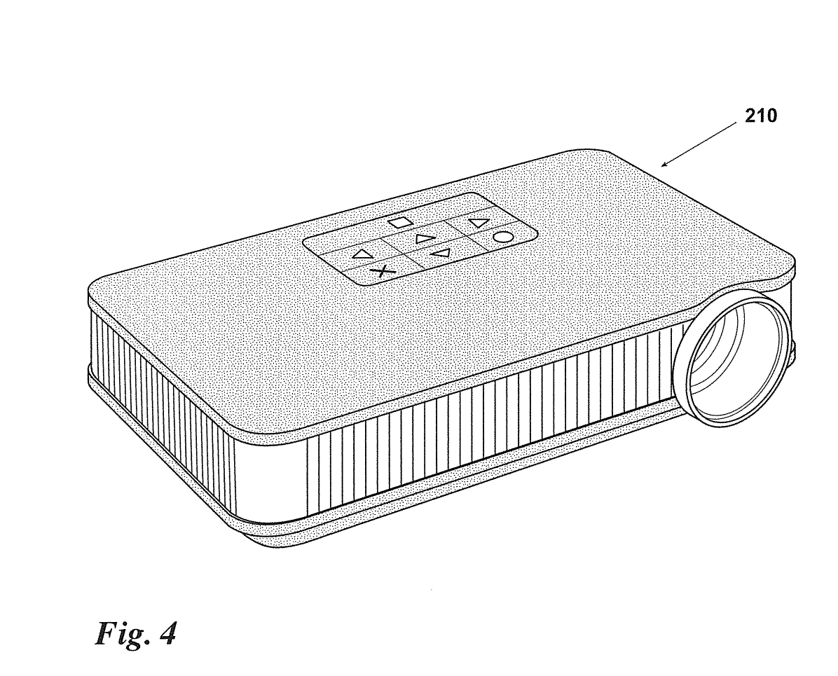

Turning to FIG. 2 in combination with FIG. 3, in one preferred embodiment, housing 114 of teleprompter 100 includes a right side 200, a left side 202, a top 204, and a back 206. A projector mount 208 is provided on top 204 to support projector 210. A lens 212 may be provided to allow the image projected from projector 210 to focus on screen 214 while properly sizing the image for reflection in reflective surface 216. Most preferably, projector 210 is in a class of video projectors commonly referred to as “pico-projectors.” As will be readily understood by one of ordinary skill in the art, a pico-projector 210 (FIG. 4) is typically characterized by: LED illumination for ruggedness and long lamp life; extremely small size, at least partially made possible by the simplicity of LED illumination; low power consumption; and light weight. Many pico-projectors employ digital light processing (DLP) technology, but other imaging technologies are likewise suitable for use with the present invention. By way of example and not limitation, such technologies include: liquid crystal projectors; liquid crystal on silicon (LCoS); and the like. One such exemplary pico-projector suitable for the teleprompter of the present disclosure is the model PK201 manufactured by Optoma Technology of Fremont, Calif. However, it is understood that other pico-projectors could be substituted.

Referring back to FIGS. 2 and 3, housing back 206 includes aperture 218 which accommodates the lens 220 of camera 222. Camera 222 is positioned so that lens 220 looks forward, through aperture 218, along axis 120 (FIG. 1), and through reflective surface/reflector 216. As will be apparent to one of ordinary skill in the art, reflective surface 216 is positioned such that the image projected on projection screen 214 will be partially reflected along axis 120 of lens 220, away from (forward) the camera and partially transmitted vertically into top 204. Ideally, virtually none of the image will be reflected towards the camera, and if some of the image is, it will be grossly out of focus as the camera lens 220 is focused on the subject well beyond the reflective surface 216.

Thus, with reference to FIG. 1, camera 102 has a frusto-pyramidal field-of-view looking forward along axis 120. A person standing within the field-of-view, looking rearward along axis 120 will see the image projected by projector 116 in front of the camera lens 220 (FIG. 3). Reflective surface/reflector 112 is mounted proximate the front of the camera lens so that when the talent is reading from the prompter, he or she will look directly into the lens.

As is well known in the art, high contrast ratios are paramount to produce an easy-to-read image on a prompter. In projection video systems, a white projection screen is often the limiting factor as to contrast ratio, since even in the absence of projected light, the screen is still white from ambient light. Returning to FIG. 1, to overcome this trait, screen 118 is constructed of a material that enhances the contrast ratio over that of a conventional white screen. One exemplary material that provides enhanced contrast is available from Screen Innovations of Austin Tex.

Other issues that affect performance of the prompter are distortion and hot-spots in the image. Essentially, lens 212 (FIG. 2) is a wide angle lens to produce a suitable image size in light of the short projection distance between top 204 (FIG. 2) and screen 118. The image tends to distort towards the outer edges. Two methods are possible to overcome this effect: 1) additional optics to restore the image; or 2) correcting the image in software before projection. The advantage to the second method is that there is no added cost, but there is a reduction in apparent resolution since part of the viewable image is lost in correcting the distortion.

Hot-spots, or bright areas, in the image are also related to the relative large projected image size to the distance over which the image is projected. Obviously the lens is substantially closer to the center than are the outside edges. This difference in projection distance causes the center of the screen to be brighter than the edges. Again, this affect can be remedied either optically or through software. While the software solution results in lower parts cost, the overall brightness of the prompter is reduced. With reference to FIG. 1, screen 118 can be curved in a concave manner so that all points on the surface of screen 118 along axis 120 of the camera lens are equidistant to the projector lens 212. While a bowl-like shape may be ideal to solve the issues with distortion and hot-spots, it has been found that a simple curve in screen 118 (as can be seen in FIG. 1) provides adequate results. As will be apparent to one of ordinary skill in the art, in light of the present disclosure, a combination of optical solutions and software solutions may also be employed to provide a reasonable compromise between increased hardware complexity and sacrificing resolution or brightness.

Continuing with reference to FIGS. 2 and 3, several options for fixing prompter 100 to camera 222 are available. By way of example and not limitation, such options include: using adapter rings, which are well known in the art, to attach the prompter to the lens of the camera; using a rail system, which are likewise well known in the art, to attach the prompter to the bottom of the camera; attaching the prompter to a support and affixing the camera to the prompter; or attaching the camera to a support and affixing the prompter to the camera.

The size and weight of the inventive prompter is particularly well suited for use with a shoulder camera. Such cameras find wide use in sideline shots during sporting events, coverage of breaking news stories, and the like. It should also be noted that a receiver may be mounted to prompter 100 or camera 222 to receive video information from the production staff and display the information on the prompter. Thus, the on-air talent may be fed information in real time, even in so-called “run and gun” applications.

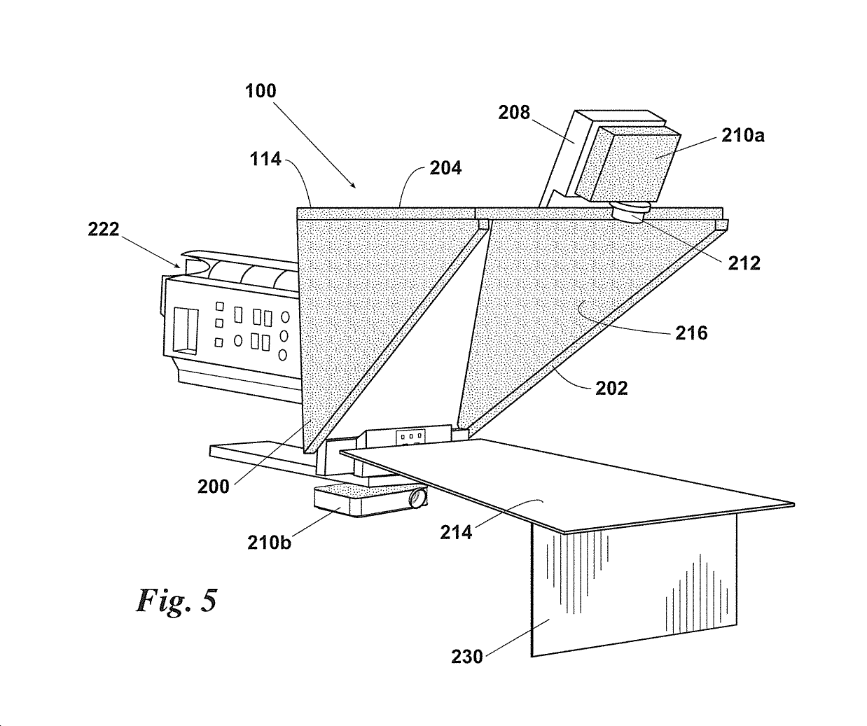

Turning to FIG. 5, optionally, a talent or on-air monitor 230 may be attached to housing 114 or suspended below screen 214. Talent monitors allow the subject to see either how she or he looks or allows the talent to see video actually being broadcast. In a preferred embodiment, projector 210b, mounted rearward of screen 230, projects a video image onto rear projection screen 230. Optionally, a skirt, or rigid, housing (not shown) may be constructed around the periphery of screen 230 towards projector 210b to reduce the effects of ambient light on the projected image. Using pico-projector 210b in conjunction with screen 230 reduces the cost and weight of the talent monitor as compared to using an LCD monitor, as found with traditional prompters.

As will be apparent to one of ordinary skill in the art, video can be delivered to projectors 210a and 210b in precisely the same manner as video is delivered to present day prompters, optionally including a talent monitor. Further, it will be apparent that housing 114 may be adapted to accommodate one or more microphones for receiving audio from talent, or accommodating one or more small video lights, or catch lights, to improve the facial lighting of on-air talent.

It will be still further apparent that, to reduce overall size and weight of the entire prompter system, that the camera number, color coding of the camera number to indicate the active camera, time, and other like features may be overlaid on the video presented on the talent monitor along with the appropriate video feed. Techniques for overlaying information in video are well known in the art and include such techniques as: inserting a box or figure over the incoming video and posting information of a selected color and brightness over a known background; inserting a translucent box or figure over the incoming video so that the posted information is known to be readable but the viewer can still see what is happening underneath the inserted information; or overlaying characters directly on the video, although doing so requires some processing of the underlying video to find a color and brightness for the characters which will be visible over the video signal; as well as others techniques.

While preferred embodiments of the invention have been described herein, many variations are possible which remain within the concept and scope of the invention. Such variations would become clear to one of ordinary skill in the art after inspection of the specification and the drawings.

The embodiments herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A teleprompter for use with a camera having a lens with a field of view defined by an axis in a forward direction, said teleprompter comprising:
a reflector supported proximate the lens;
a projection screen supported forward of said reflector;
a projector supported forward of said reflector for projecting an image on said projection screen so that said image is capable of reflection by said reflector along the axis.

2. The teleprompter of claim 1 wherein said reflector is positioned at an angle suitable to reflect said image along the axis.

3. The teleprompter of claim 1 further including a hood positioned forward of the lens.

4. The teleprompter of claim 3 wherein said reflector is positioned in said hood at an angle suitable to reflect said image along the axis.

5. The teleprompter of claim 4 wherein said angle is approximately 45 degrees.

6. The teleprompter of claim 3 wherein said hood includes at least a top and a back.

7. The teleprompter of claim 6 wherein said back includes an aperture through which the lens extends.

8. The teleprompter of claim 7, wherein said projector is supported from said hood and said projection screen is supported from said hood wherein said projector is supported from said hood so as to project said image to said projection screen opposite the field of view of the lens.

9. The teleprompter of claim 8 wherein the hood includes two sides wherein said sides are opposite the field of view.

10. The teleprompter of claim 7 wherein said projector is supported from said top and said projection screen is positioned so as to substantially form a bottom of said hood.

11. The teleprompter of claim 10 wherein the hood includes a first side and a second side such that said first side is positioned opposite the field of view from the second side.

12. The teleprompter of claim 1 wherein said projection screen is curved.

13. The teleprompter of claim 1 wherein said projection screen is substantially concave.

14. The teleprompter of claim 8 wherein said projection screen is substantially concave.

15. The teleprompter of claim 1 further including a talent monitor.

16. The teleprompter of claim 15 wherein said talent monitor is capable of projecting a camera status.

17. The teleprompter of claim 15 wherein said talent monitor is capable of projecting a timer.

18. The teleprompter of claim 1 further including a talent monitor comprising:
a rear projection screen suspended below said projection screen; and
wherein said projector is a first projector and further including a second projector supported rearward of said rear projection screen such that an image projected from said second projector is projected on said rear projection screen.

19. The teleprompter of claim 18 wherein said talent monitor is capable of projecting a camera status.

20. The teleprompter of claim 18 wherein said talent monitor is capable of projecting a timer.
